(19) United States
(12) Patent Application Publication
(10) Pub. No.: US 2022/0304253 A1
(43) Pub. Date: Sep. 29, 2022

(54) Raised Bed Planter

(71) Applicant: Brandon Lee Brewer, Farmington, UT (US)

(72) Inventor: Brandon Lee Brewer, Farmington, UT (US)

(21) Appl. No.: 17/212,998

(22) Filed: Mar. 25, 2021

(51) Int. Cl. A01G 9/28; A01G 13/02

(52) U.S. Cl. CPC A01G 9/28; A01G 13/0268; A01G 2013/006

(57) ABSTRACT

A bed for planting in is disclosed. The bed includes panels for creating a frame. A liner, comprising a rip-resistant material, that fits within the frame and is attached thereto. Each panel includes spaces to access the liner. The material of the liner permits slits to be made in it without the slit expanding. Any slits made in the liner are located in the spaces within the panels. The liner is filled with grow medium. Plants are planted in the grow medium and grow out of the upper surface of the grow medium in the liner. Slits are placed in the liner, and plants are placed in the grow medium to grow through the slits. A method for creating a bed to plant in is also disclosed

### CROSS-REFERENCE TO RELATED APPLICATIONS

This application claims priority to provisional patent 62/992,987 filed Mar. 21, 2020 and titled Raised-Bed Garden System.

### TECHNICAL FIELD

The present invention relates to ornamental and agricultural plant growth, plant support, plant propagation, and plant containment systems and containers.

### BACKGROUND

Many plant containment and plant growth systems exist. Raised-bed gardens have simplified gardening by keeping plant material more accessible than traditional in-ground plantings. They have also made weed control less work as many raised beds are filled with weed free media.

As convenient as raised-bed systems have become, many of these systems are complicated to assemble, require specific tools to erect, and are limited to certain sizes and shapes. These limitations prevent people from using these systems in areas that need a fast, simple, and dynamic solution.

Existing garden boxes, raised beds, and other plant containment systems offer horizontal or vertical grow surfaces. An affordable system that is dynamic, modular, and offers both vertical and horizontal grow surfaces does not currently exist. The present invention fills the need for such a system.

### SUMMARY

In a first aspect, the disclosure provides a bed for planting in. The bed includes panels for creating a frame. A liner, comprising a rip-resistant material, that fits within the frame and is attached thereto. Each panel includes spaces to access the liner. The material of the liner permits slits to be made in it without the slit expanding. Any slits made in the liner are located in the spaces within the panels. The liner is filled with grow medium. Plants are planted in the grow medium and grow out of the upper surface of the grow medium in the liner. Slits are placed in the liner, and plants are placed in the grow medium to grow through the slits.

In a second aspect the disclosure provides a method for creating a bed to plant in. Attaching panels together to form a frame. Attaching a rip resistant liner to the frame. Filling the liner with grow medium. Placing slits in the liner to access the grow medium. Each panel includes spaces to access the liner. The material of the liner permits slits to be made in it without the slit expanding. Any slits made in the liner are located in the spaces within the panels. The liner is filled with grow medium. Plants are planted in the grow medium and grow out of the upper surface of the grow medium in the liner. Plants are planted in the grow medium to grow out of the slits in the liner.

Further aspects and embodiments are provided in the foregoing drawings, detailed description, and claims.

### BRIEF DESCRIPTION OF THE DRAWINGS

The drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a one embodiment of a frame of the raised garden bed.

FIG. 2 is one embodiment of the frames being attached together with rings.

FIG. 3 is one embodiment of a ring clasp.

FIG. 4 is an embodiment where the frame is lying flat.

FIG. 5 is an embodiment in a rhomboidal shape.

FIG. 6 is an embodiment with one side extended to act as a trellis.

FIG. 7 is an embodiment with additional sides attached above the frame.

FIG. 8 is an embodiment attaching multiple frames together to create a larger raised bed.

FIG. 9 is an embodiment of a liner.

FIG. 10 is an embodiment where a frame and inserted liner are filled with grow media and have plants growing from the top and through the liner of the raised bed.

FIG. 11 is an embodiment where a frame and inserted liner are filled with grow media and have plants growing from the top and through the liner of the raised bed up a higher frame side which acts as a trellis.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

Definitions

The following terms and phrases have the meanings indicated below, unless otherwise provided herein. This disclosure may employ other terms and phrases not expressly defined herein. Such other terms and phrases shall have the meanings they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly indicates otherwise. For example, reference to “a substituent” encompasses a single substituent as well as two or more substituents, and the like.

As used herein, “for example,” “for instance.” “such as,” or “including” are meant to introduce examples that further clarify more general subject matter. Unless otherwise expressly indicated, such examples are provided only to aid in understanding embodiments illustrated in the present disclosure and are not meant to be limiting in any fashion. Nor do these phrases indicate any kind of preference for the disclosed embodiment.

The raised-bed garden system comprises one or more grow-bed units that can be utilized as one unit or as multiple units erected side by side and adjusted to various configurations. Each grow-bed unit has four tangible vertical walls made up of a rigid frame and a flexible interior liner and has two intangible horizontal surfaces. The intangible surfaces are the surfaces that become the grow-bed unit's horizontal grow surface and the contact surface between the grow-bed unit and the surface it is placed on.

Each grow-bed unit comprises a rigid frame made primarily of, but not limited to, four galvanized welded wire panels and a flexible inside liner. The four welded wire panels are connected at each vertical end of each panel to the adjacent panel by multiple rings, or other similar connectors. The rings, or similar connectors, act as hinges allowing each of the four panels to fold against the adjacent and opposing panels until the grow-bed unit lays flat. The hinge-like connectors are also what allow each grow-bed unit to change shape. The transformed shape is observed from an aerial view once the grow-bed unit is erected.

The welded wire panels have both vertical and horizontal wires that have been galvanized and welded in a rectangular grid-like pattern. Each horizontal welded wire in each panel runs horizontally from one side of the panel to the other and ends flush with each outermost vertical welded wire of each panel. The vertical welded wires of each panel end flush with the uppermost horizontal wire of each panel but protrude multiple inches beyond the lowermost horizontal welded wire. These protruded sections of the vertical welded wires of each panel act as stabilizing stakes for each grow-bed garden unit. These sections of wire can be removed if the grow-bed units are to be utilized on a solid surface.

The openings between the horizontal and vertical welded wires are areas that allow for sections of the liner of each grow-bed unit to be exposed. These exposed areas of the liner are where slits can be made in the exterior of the liner for plants to be installed into the vertical wall of each unit.

The liner of each grow-bed unit is constructed of breathable, UV resistant material that holds soil or other grow media inside the frame of each unit. The liner is placed on the inside of the frame and covers the entirety of the inside of the frame. Once installed, the liner extends above the uppermost aspect of the frame and extends to the lowermost aspect of the frame allowing the soil or grow media inside each frame to stay in place while the grow-bed unit is being utilized. The liner is flexible and is able to conform to any of the rhomboidal/cuboidal shapes the grow-bed unit frame holds.

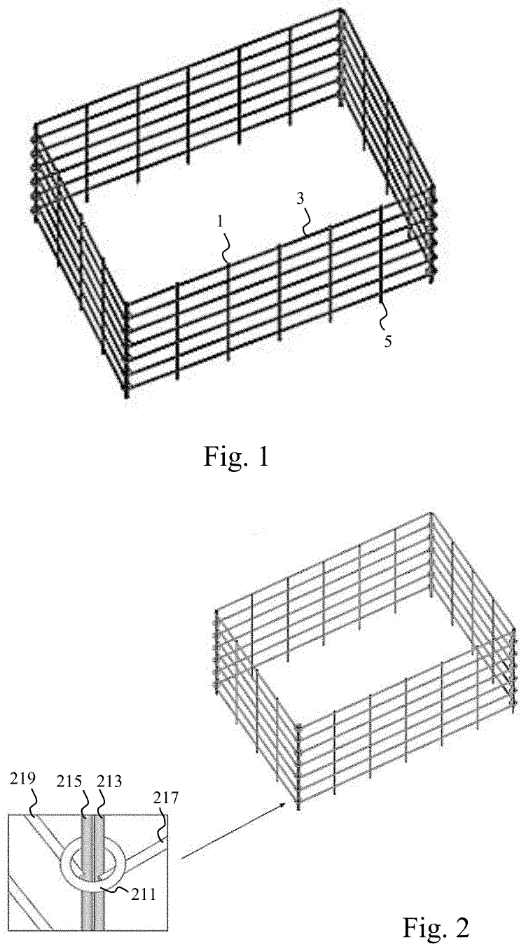

Now referring to FIG. 1 the frame of each unit of the grow-bed is made in an open grid, of vertical members, such as vertical member 1 and horizontal members, such as horizontal member 3. There can be any number of horizontal and vertical members. Typically, there are between four and nine horizontal members. The height of the frame can be any height. In some embodiments, the frame is twelve inches high. In other embodiments the frame is forty inches high. The frame can be any height between them. There can be between four and twelve vertical members. In some embodiments the frame sides are twenty inches wide. In some embodiments the frame sides are sixty inches wide. The size of the frame can be adjusted based on the location where the frame is going to be located. The frame size can also be determined for specific applications. The frame is made from materials that are strong enough to keep the frame upright. It is also desirable that the materials be resistant to decay, especially from moisture and UV light. In most embodiments the vertical and horizontal members are round in cross section. In some embodiments the horizontal and vertical members are other shapes in cross section, such as square, rectangle, diamond or other shapes. The preferred material for the frame is galvanized steel. In this embodiment the vertical and horizontal frame members are heavy gage round stock, sometimes referred to as heavy gage wire. Galvanized steel is advantageous because the vertical and horizontal frame members can be welded together, which creates additional strength for the frame. Welding the vertical and horizontal members also makes each side of the frame a solid unit. Having each side of the frame be a solid unit enlarges the possible configurations. In other configurations the frame is made of non-galvanized steel. There is a disadvantage to non-galvanized steel, including its propensity to rust. In some embodiments the steel is protected by a surface coating, some of those surface coatings include powder coatings, paint coatings, or synthetic coatings. In other embodiments, the frame members are made from stainless steel. In yet other embodiments, the frame is made from a synthetic material, such as nylon, plastic, or carbon fiber. In some embodiments, the vertical members extend past the lowest of the horizontal members. In these embodiments, the portion of the vertical member extending past the lowest horizontal member functions as a stake, such as stake 5, to hold the frame in place. These embodiments are particularly well suited for use where the stakes can be secured in the ground, such as in a homeowner's yard. In other embodiments, the vertical members stop at the lowest horizontal member. These embodiments are well suited for use on hard surfaces, such as a homeowner's driveway.

The frame typically includes four sides. In other embodiments the frame includes other numbers of sides, some embodiments have three sides, while others have between five and six sides. The most common embodiment includes four sides. In embodiments, with four sides there are generally two sizes of sides, a longer size and a smaller size, this configuration typically results in a frame that is rectangular in shape. The sides can all be the same size, or they can all be of different sizes. The most common configurations have either one or two sizes of sides.

The frame sides are attached together so that the sides can articulate relative to one another. In this way, the frame can be positioned in different shapes. The In one embodiment the frame sides are attached together with rings, such as ring 211. Ring 211 encircles outside vertical members 213 and 215 of the frame sides. In some embodiments the rings are positioned at every horizontal member such as horizontal members 217 and 219. In other embodiments, the rings are positioned at the top and bottom horizontal members. In some embodiments, the rings are affixed to the horizontal members of one of the frame sides. In other embodiments the rings are not affixed to the frame sides.

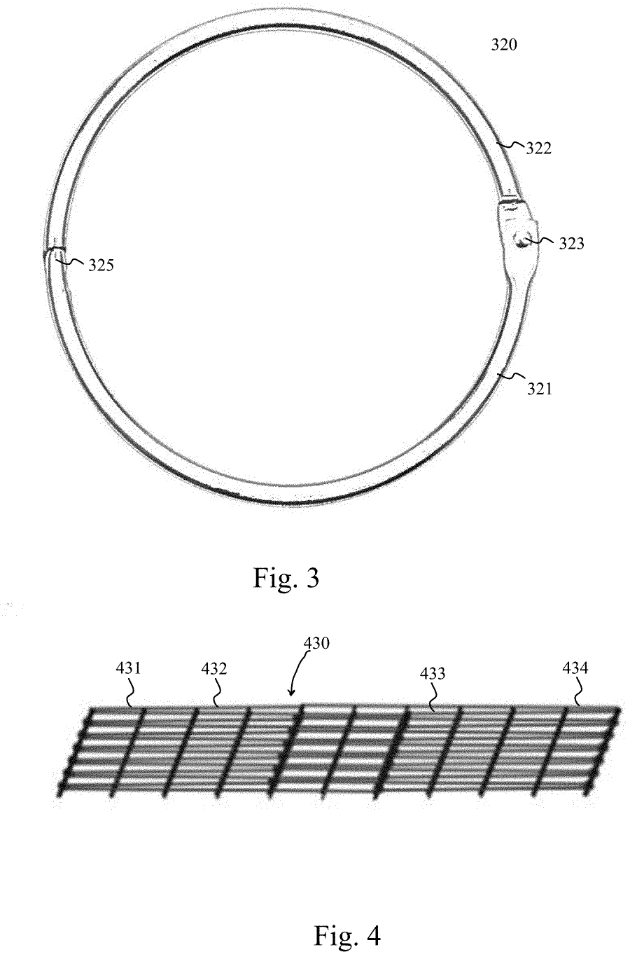

In some embodiments, the rings are solid, and permanently connect the frame sides together. In other embodiments, the rings are ring clasps. Rings that open and secure shut. The ring clasps enable the frame sides to be removed from one another. FIG. 3 is a ring clasp. Ring clasp 320 has two sides 321 and 322 which are secured together by rivet 323. On the opening side which is opposite side the rivet is on; the two halves of the ring are able to separate so that the ring can be opened. Opening the ring allows multiple vertical members to be placed within the ring so that the frame sides can be made into a frame. The two sides of the ring secure each other together at lock 325. Lock 325 is powerful enough to hold the ring together so the ring can hold frame sides together.

The frame is designed so that it can lay flat, such as in FIG. 4. Frame 430 includes frame sides 431, 432, 433, and 434 which are affixed together. In these embodiments, the frame must include an even number of frame pieces to lay flat. In other embodiments, the frame pieces are removably affixed together, that is the frame pieces can be detached from one another. These removably affixed frame sides utilize ring clasps such as those described in FIG. 3.

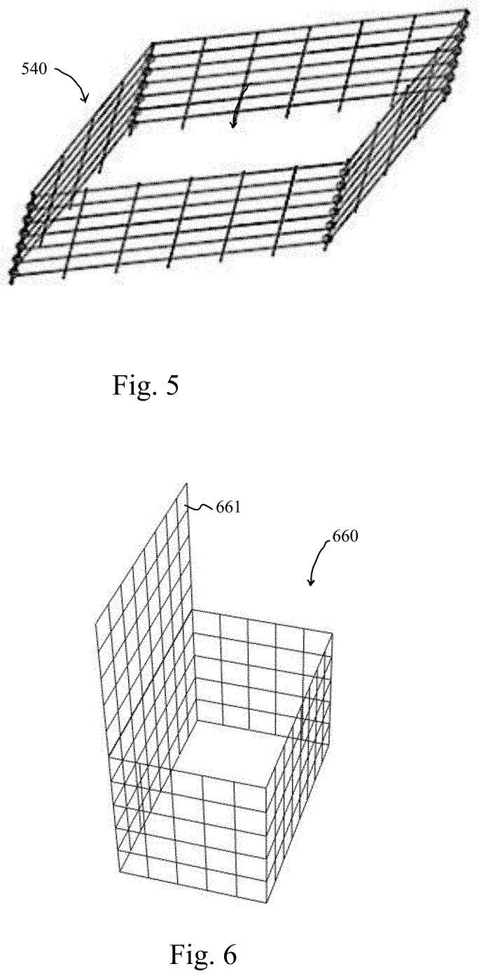

The frame can be configured in various shapes. As explained above rectangular or square shapes are the most common. Other shapes are used to make the planter appear decorative or fit in spaces that are not arranged with right angles. FIG. 5 shows one configuration where the shape is rhomboidal. Frame 540 is composed of four frame sides. In some embodiments, the rings that affix the frame sides together are solid rings which are not removable from the frame sides. In other embodiments, the rings are removably attached to the frame sides.

In some embodiments, at least one of the frame sides extends higher. FIG. 6 shows frame 660, which includes frame side 661. Frame side 661 extends higher than the other frames sides. Frame side 661 is twice the height of the other frame sides. The higher frame side allows plants to use the frame side as a trellis. In some embodiments, there is one side that extends higher to be used as a trellis. In other embodiments, two sides extend higher to be used as a trellis. In yet other embodiments, three sides are higher to be used as a trellis. In yet other embodiments, half of the frame sides are used as trellises. In some embodiments, all the frame's sides are tall enough to be used as trellises. In any configuration the higher frame sides are solid frame sides that is the frames sides are a rigid frame side.

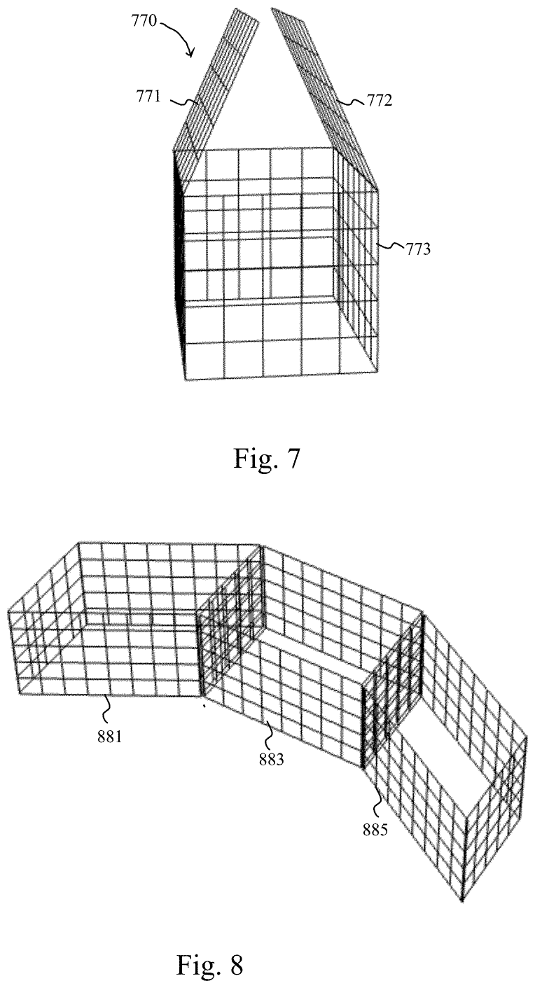

In some embodiments, additional frame sides, which are the same size as the base frame are used to extend the height of the frame. FIG. 7 shows frame 770 with base frame 773 and extender sides 771 and 772. The additional frame sides 771 and 772 are attached with rings. Extender sides 771 and 772 are positioned so that the top of each extender side points toward the midline. Attaching the additional frame sides with rings enables the upper portion to be positioned in various configurations. In some embodiments, a single additional frame side is added to increase the height of one of the frame sides. In other embodiments, multiple additional frame sides are added to increase the height of multiple frame sides. In some embodiments, the additional frame sides are connected together. The additional frame sides give support to one another when connected together. The additional frame sides can be connected together along the side of the additional frame side or along the top of the additional frame sides. The additional upper frame sides can be positioned in various configurations. In some embodiments, the additional upper frame sides are vertical. In some embodiments, the additional upper frame sides are positioned so their tops point toward the midline of the frame. In some embodiments, the upper frame sides are positioned so that they point away from the frame.

Multiple frames can be attached together to form a larger frame. FIG. 8 shows an embodiment where three frames are attached together. Frame 881 is attached to frame 883 which is attached to frame 885. In this embodiment there are three distinct frames which are attached together. The advantage to having three distinct frames is that they can be positioned apart from one another. Frames 881 and 885 are configured around a central frame 883. Typically, the frames are attached together by rings. Utilizing ring clasps enables the frames to be easily detached from one another and reattached. In some embodiments, there is a single frame and not three distinct frames. These embodiments have a single frame side between the frame parts. While this limits the ability to separate the frames for use individually, it makes the overall weight of the frame lower.

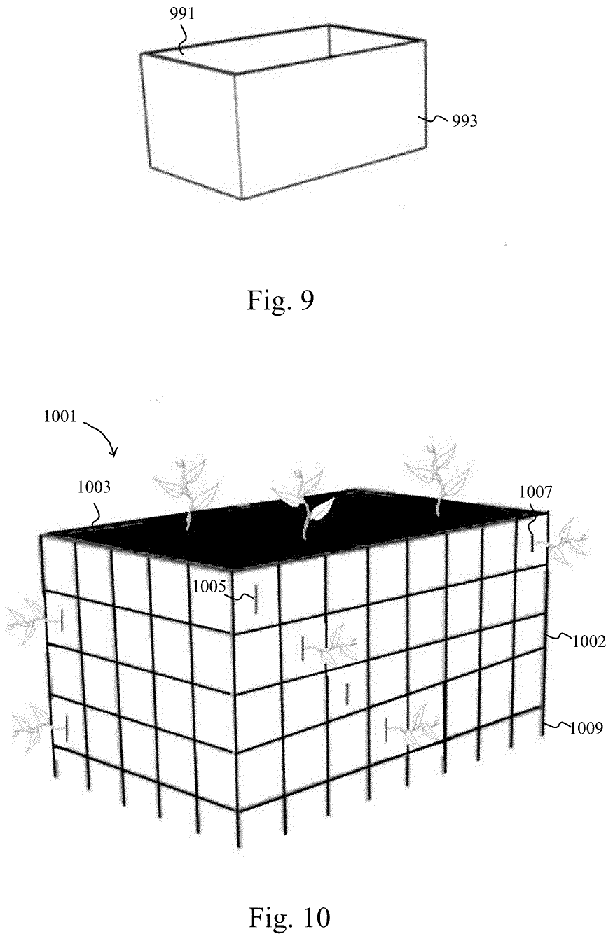

The raised bed is a modular system. In addition to the frame, the liner is attached to the frame. FIG. 9 depicts the liner 993. The liner is composed of a flexible material. The material is a breathable, UV resistant material. The liner is placed inside the frame. The liner is essentially a bag who's interior 991 is filled with grow medium for growing plants. The liner is flexible so that it can conform to any of the shapes the frame can be configured in.

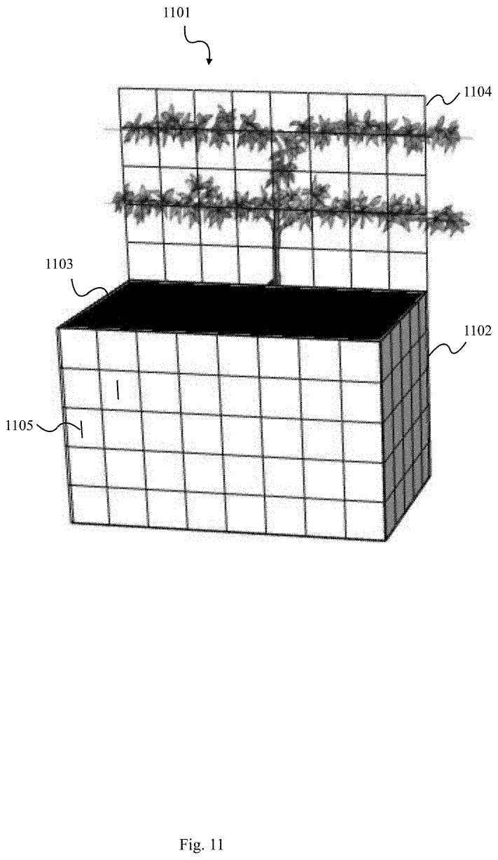

Placing the liner inside the frame creates a raised garden bed that is used for growing plants. FIG. 10 shows a fully assembled raised garden bed 1001. A frame 1002 is attached to a liner 1003. The liner is filled with soil or other grow media. Plants are planted in the raised bed and grow from the surface of the raised bed. In addition to the surface of the raised bed, plants can be planted through slits in the liner, such as slits 1005 and 1007. The liner material is configured to hold grow media and resist degradation from moisture and UV rays. The material is able to be cut, but it is strong and tough enough to resist further expansion of the slits. Slit 1005 has been cut so that a seed or seedling can be planted in the grow media behind the liner. Slit 1007 has a seedling growing from the slit. By utilizing the vertical side area of the garden bed, the available planting area is increased.

Placing the liner inside the frame creates a raised garden bed that is used for growing plants. FIG. 11 shows a fully assembled raised garden bed 1101. A frame 1102 with a side extended higher is attached to a liner 1103. The liner is filled with soil or other grow media. Plants are planted in the raised bed and grow from the surface of the raised bed. The higher side 1104 acts as a trellis to support plants planted near the extended higher side. A tree has been espaliered to the higher side 1104 of the frame 1102. In other embodiments, the higher side of the frame acts as a trellis for climbing plants, such as beans, peas, grapes, or vines. As described above, in addition to the surface of the raised bed, plants can be planted through slits in the liner, such as slit 1105. The liner material is configured to hold grow media and resist degradation from moisture and UV rays. The material is able to be cut, but it is strong and tough enough to resist further expansion of the slits. By utilizing the vertical side area of the garden bed, the available planting area is increased.

All patents and published patent applications referred to herein are incorporated herein by reference. However, any reference to prior publication is not, and should not be taken as an acknowledgement, admission, or suggestion that the prior publication, or any information derived from it is part of the general common knowledge in the field of endeavor to which this specification relates. The invention has been described with reference to various specific and preferred embodiments and techniques. Nevertheless, it is understood that many variations and modifications may be made while remaining within the spirit and scope of the invention.

1. A bed for planting in, comprising:
panels comprising vertical and horizontal members for creating a frame;
a liner, comprising a rip-resistant material, that fits within the frame and is attached thereto;
wherein each panel includes spaces to access the liner;
wherein the material of the liner permits slits to be made in it without the slit expanding;
wherein any slits made in the liner are located in the spaces within the panels;
wherein the liner is filled with grow medium;
wherein plants are planted in the grow medium and grow out of the upper surface of the grow medium in the liner;
wherein slits are placed in the liner, and plants are placed in the grow medium to grow through the slits;
wherein each panel is attached to a neighboring panel by attaching at least one ring, which is removable from each panel, to an outermost vertical member of each panel.

2. The bed for planting in of claim 1, wherein the horizontal and vertical members are arranged in a grid pattern.

3. The invention of claim 2, wherein the panels are removably attached together.

4. The bed for planting in of claim 3, wherein the rings are ring clasps.

5. The bed for planting in of claim 4 wherein the frame and liner can be folded flat.

6. The bed for planting in of claim 2, wherein the frame comprises four panels.

7. The bed for planting in of claim 2, wherein the frame comprises five panels.

8. The bed for planting in of claim 2, wherein the frame is adapted to be configured in multiple shapes.

9. The bed for planting in of claim 2, wherein multiple frames are attached together.

10. The bed for planting in of claim 2, wherein at least one panel is higher than the other panels.

11. The bed for planting in of claim 2, wherein the vertical members end at a bottom horizontal member.

12. The bed for planting in of claim 2, wherein the vertical members extend past a bottom horizontal member.

13. The bed for planting in of claim 9, wherein a group of extended vertical members secure the frame to a specific location in the ground.

14. A method for creating a bed to plant in, comprising:
attaching panels comprising vertical and horizontal members together to form a frame;
attaching a rip resistant liner to the frame;
filling the liner with grow medium;
placing slits in the liner to access the grow medium;
wherein each panel includes spaces to access the liner;
wherein the material of the liner permits slits to be made in it without the slit expanding;
wherein any slits made in the liner are located in the spaces within the panels;
wherein the liner is filled with grow medium;
wherein plants are planted in the grow medium and grow out of the upper surface of the grow medium in the liner;
wherein plants are planted in the grow medium to grow out of the slits in the liner;
wherein each panel is attached to a neighboring panel by attaching at least one ring, which is removable from each panel, to an outermost vertical member of each panel.

15. The method of claim 14, wherein the panels comprise horizontal and vertical members in a grid pattern.

16. The method of claim 14, wherein the panels are removably attached together.

17. The method of claim 15, wherein the panels are attached with split rings.

18. The method of claim 14, wherein the frame is adapted to be configured in multiple shapes.

19. The method of claim 17, wherein multiple frames are attached together.

20. The method of claim 17, wherein at least one panel is higher than the other panels.
